(19) United States
(12) Patent Application Publication
(10) Pub. No.: US 2007/0018937 A1
(43) Pub. Date: Jan. 25, 2007

(54) DRIVING DEVICE FOR DRIVING AN LCD MONITOR

(76) Inventors: Jiunn-Yau Huang, Tainan County (TW); Chien-Hsin Li, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/161,073

(22) Filed: Jul. 21, 2005

(51) Int. Cl. G09G 3/36

(52) U.S. Cl. 345/100

(57) ABSTRACT

A driving device for driving an LCD monitor, includes: a power supply comprising power transmission lines for carrying voltages; and driving units capable of driving an LCD panel of the LCD monitor according to the voltages carried by the power transmission lines. Each driving unit comprises an output buffer and switches. One of the switches is coupled to a power source for selectively transmitting the power provided by the power source to turn on the output buffer.

### BACKGROUND OF THE INVENTION

1. Field of the Invention

The present invention relates to liquid crystal display (LCD) driving, and more particularly, to a driving device for driving an LCD monitor.

2. Description of the Prior Art

The advantages of the liquid crystal display (LCD) include lighter weight, less electrical consumption, and less radiation contamination. Thus, the LCD has been widely applied to portable information products such as notebooks, and Personal Digital Assistants (PDAs). In addition, LCD panels have gradually replaced cathode ray tubes (CRTs) in monitor applications of desktop computers.

Light rays from a backlight module within an LCD monitor are typically polarized by a first polarizer and then converted into light rays of different polarization directions by utilizing various arrangements of liquid crystal molecules within an LCD panel controlled by certain driving voltages provided by a driving device within the LCD monitor. Color filters and a second polarizer are applied, in order to generate red, blue, and green lights with different intensities of gray levels. As the increased number of gray levels is typically a characteristic of an advanced LCD monitor with respect to others, more accurate driving voltages are required, where uniformity control by averaging driving voltages to be utilized for the same gray level is a typical method for controlling the accuracy of the driving voltages. Please refer to US Patent Application Publication No. US 2003/0234757 and U.S. Pat. No. 6,366,065 for more information.

### SUMMARY OF THE INVENTION

It is an objective of the claimed invention to provide driving devices for driving liquid crystal display (LCD) monitors.

According to one embodiment of the claimed invention, a driving device for driving an LCD monitor is disclosed. The LCD monitor comprises an LCD panel for displaying a plurality of pixels arranged in a matrix format. The driving device comprises: a power supply comprising a plurality of power transmission lines for carrying a plurality of voltages; and a plurality of driving units capable of driving the LCD panel according to the voltages carried by the power transmission lines. Each driving unit comprises: an output buffer having a first input terminal and an output terminal connected to each other, where the output terminal of the output buffer is connected to an output terminal of the driving unit; a first switch coupled to a power source for selectively transmitting the power provided by the power source to turn on the output buffer; and a second switch coupled between the output terminal of the driving unit and a second input terminal of the output buffer.

According to one embodiment of the claimed invention, a driving device for driving an LCD monitor is disclosed. The LCD monitor comprises an LCD panel for displaying a plurality of pixels arranged in a matrix format. The driving device comprises: a power supply comprising a plurality of power transmission lines for carrying a plurality of voltages; and a plurality of driving units capable of driving the LCD panel according to the voltages carried by the power transmission lines. Each driving unit comprises: an output buffer having a first input terminal coupled to one of the power transmission lines, where an output terminal of the output buffer is connected to an output terminal of the driving unit; a first switch coupled to a power source for selectively transmitting the power provided by the power source to turn on the output buffer; and a second switch coupled between the first input terminal and a second input terminal of the output buffer.

According to one embodiment of the claimed invention, a driving device for driving an LCD monitor is disclosed. The LCD monitor comprises an LCD panel for displaying a plurality of pixels arranged in a matrix format. The driving device comprises: a power supply comprising a plurality of power transmission lines for carrying a plurality of voltages; and a plurality of driving units capable of driving the LCD panel according to the voltages carried by the power transmission lines. Each driving unit comprises: an output buffer having a first input terminal coupled to one of the power transmission lines, where an output terminal of the output buffer is connected to an output terminal of the driving unit; a first switch coupled to a power source for selectively transmitting the power provided by the power source to turn on the output buffer; a second switch coupled between the first input terminal of the output buffer and the output terminal of the driving unit; and a third switch coupled between the output terminal of the output buffer and a second input terminal of the output buffer.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a driving device according to one embodiment of the present invention.

FIG. 2 illustrates voltages of the terminals E1 and E4 shown in FIG. 1.

FIG. 3 is a diagram of a driving device according to one embodiment of the present invention.

FIG. 4 is a diagram of a driving device according to one embodiment of the present invention.

FIG. 5 is a diagram of a driving device according to one embodiment of the present invention.

FIG. 6 is a diagram of a driving device according to one embodiment of the present invention.

### DETAILED DESCRIPTION

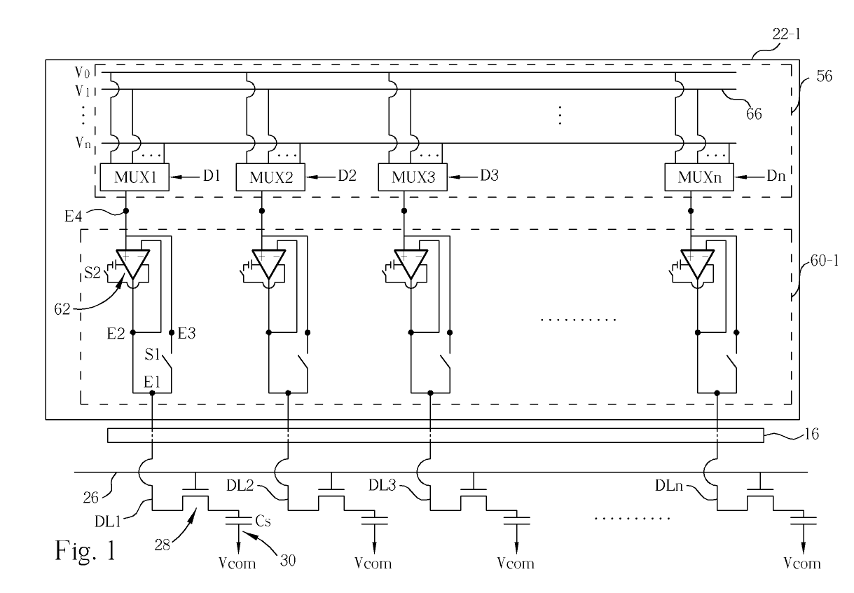

Please refer to FIG. 1. FIG. 1 is a diagram of a driving device 22-1 for driving an LCD monitor (not shown) according to a first embodiment of the present invention. The LCD monitor comprises an LCD panel for displaying a plurality of pixels arranged in a matrix format, where FIG. 1 illustrates equivalent capacitors (such as the equivalent capacitor 30) corresponding to one row of the pixels mentioned above, and each of the equivalent capacitors represents electric characteristics between two electrodes respectively positioned on two substrates of the LCD panel, where liquid crystal molecules of the LCD panel are contained between the substrates.

The equivalent capacitors are coupled to a first driving circuit 16 through thin film transistors (e.g., thin film transistor 28) controlled by a gate line 26 corresponding to the row of pixels. The equivalent capacitors are coupled to a common voltage Vcom, which is applied to one of the substrates mentioned above. The circuitry outside the driving device 22-1 has been disclosed in US Patent Application Publication No. US 2003/0234757, and is therefore not repeated in detail here.

As shown in FIG. 1, the driving device 22-1 comprises a power supply 56 comprising a plurality of power transmission lines (e.g., the power transmission line 66) for carrying a plurality of voltages V₀, V₁, . . . , and Vₙ. The driving device 22-1 further comprises a driving module 60-1 comprising a plurality of driving units capable of driving the LCD panel according to the voltages V₀, V₁, . . . , and Vₙ carried by the power transmission lines. According to this embodiment, the driving units within the driving module 60-1 are all the same. For simplicity, operations corresponding to one of the driving units are described in the following, where those corresponding to the other driving units are not repeated.

The driving unit having an output terminal E1 and an input terminal E4, comprises an output buffer 62 and two switches S1 and S2, where the output buffer 62 has a unit gain and is typically implemented utilizing an operational amplifier or an operational transconductance amplifier (OTA). The output terminal E1 is coupled to the thin film transistor 28 through a data line DL1. In addition, the input terminal E4 is coupled to one of the power transmission lines through the multiplexer MUX1 according to a control signal D1.

As shown in FIG. 1, the output buffer 62 has a positive input terminal connected to the input terminal E4, and an output terminal E2 connected to the output terminal E1. In addition, the output buffer 62 has a negative input terminal connected to the output terminal E2. The switch S1 is coupled between the positive input terminal of the output buffer 62 and the output terminal E1. Additionally, the switch S2 is coupled to a power source of the output buffer 62 for selectively transmitting the power provided by the power source to turn on the output buffer 62.

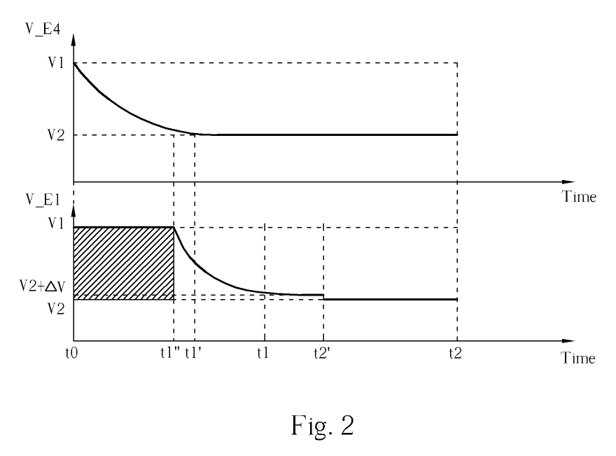

Please refer to FIG. 2. FIG. 2 illustrates voltages of the output terminal E1 and the input terminal E4 shown in FIG. 1. In a beginning period between the time points t0 and t1″ shown in FIG. 2, both switches S1 and S2 are turned off while the voltage V_E4 is driven from VI toward V2. The shaded portion under the curve of the voltage V_E1 means the power of the power source of the output buffer 62 is saved during the beginning period. In an intermediate period between the time points t1″ and t2′, the switch S2 is turned on and the switch S1 is turned off, so the voltage V₁₃ E1 is driven by the output buffer 62 from V1 toward (V2+ΔV), where ΔV is an offset due to differences between the output buffers. In an ending period between the time points t2′ and t2, the switch S2 is turned off and the switch S1 is turned on, so the output terminal E1 and those of other driving units for outputting/displaying the same gray level are connected to the same power transmission line of the power supply 56 through the corresponding multiplexers. Therefore, the voltage V_E1 reaches the averaged level of V2. In contrast to the architecture provided in U.S. Pat. No. 6,366,065, this embodiment of the present invention utilizes a smaller number of switches to reach the same purpose.

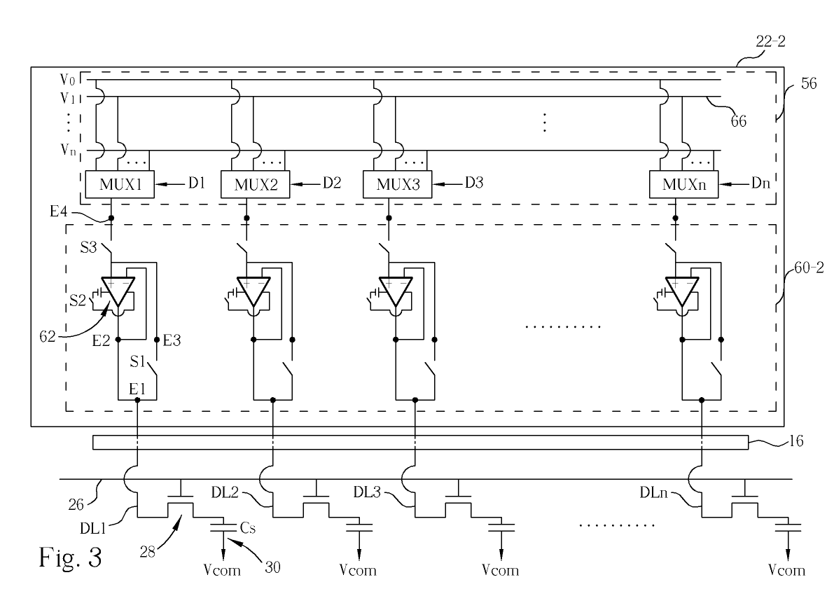

Please refer to FIG. 3. FIG. 3 is a diagram of a driving device 22-2 according to a second embodiment of the present invention. The differences between the first and second embodiments are described as follows. The driving device 22-2 further comprises a switch S3 coupled between the input terminal E4 and the positive input terminal of the output buffer 62. In the beginning period, the switches S1, S2, and S3 are turned off. In the intermediate period, both switches S2 and S3 are turned on and the switch S1 is turned off. In the ending period, the switch S2 is turned off and both switches S1 and S3 are turned on.

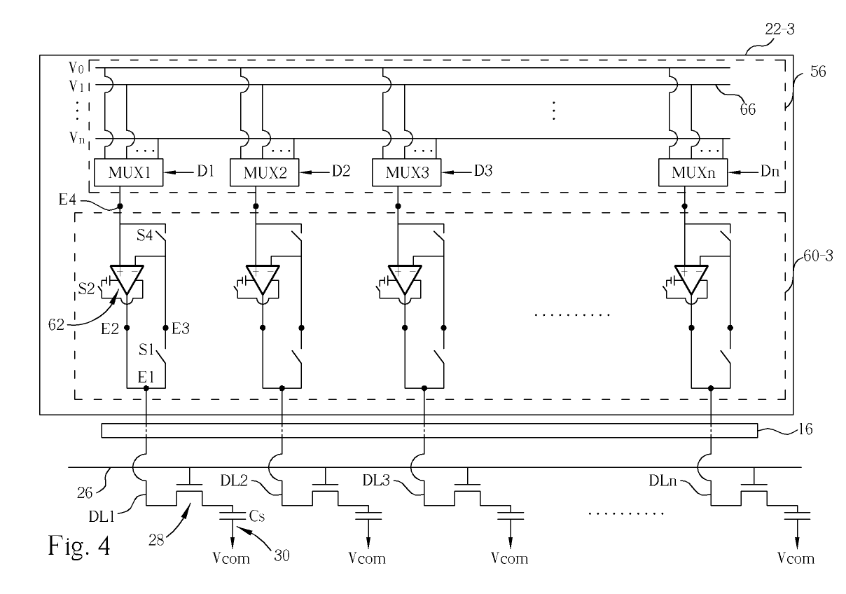

Please refer to FIG. 4. FIG. 4 is a diagram of a driving device 22-3 according to a third embodiment of the present invention. In this embodiment, a portion of connections is changed in each driving unit in contrast to the second embodiment, where a switch S4 is provided as shown in FIG. 4. Accordingly, in the beginning period, the switch S2 is turned off and at least one of the switches S1 and S4 is turned off. In the intermediate period, both switches S1 and S2 are turned on and the switch S4 is turned off. In the ending period, the switch S2 is turned off and both switches S1 and S4 are turned on.

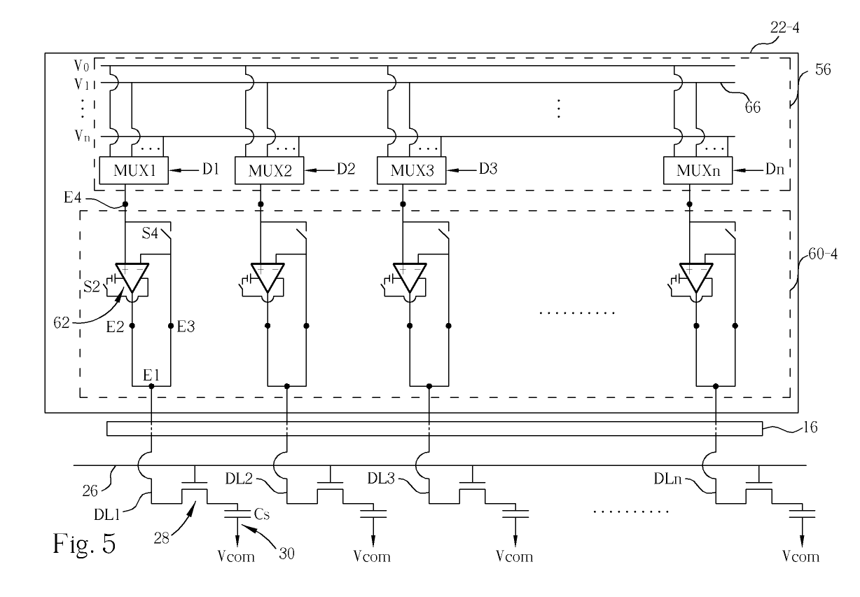

Please refer to FIG. 5. FIG. 5 is a diagram of a driving device 22-4 according to a fourth embodiment of the present invention. The fourth embodiment is simpler than the third embodiment, where the switch S1 mentioned above is not needed in the fourth embodiment. As shown in FIG. 5, the terminal E3 is connected to the output terminal E1. Accordingly, in the beginning period, the switches S2 and S4 are turned off. In the intermediate period, the switch S2 is turned on and the switch S4 is turned off. In the ending period, the switch S2 is turned off and the switch S4 is turned on.

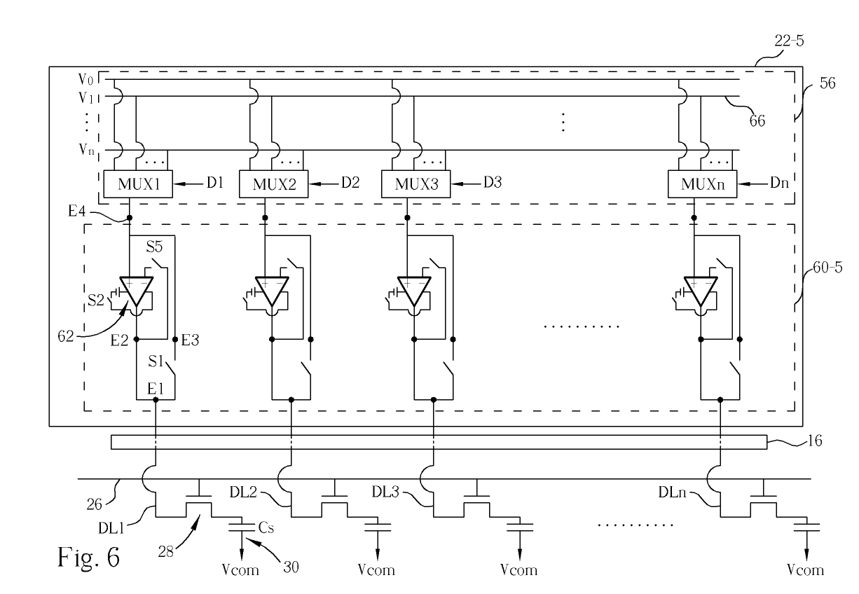

Please refer to FIG. 6. FIG. 6 is a diagram of a driving device 22-5 according to a fifth embodiment of the present invention. In this embodiment, a portion of connections is changed in each driving unit in contrast to the previous embodiments, where a switch S5 is provided as shown in FIG. 6. Accordingly, in the beginning period, at least switches S1 and S2 are turned off. In the intermediate period, the switches S2 and S5 are turned on and the switch S1 is turned off. In the ending period, at least switch S2 is turned off and at least switch S1 is turned on.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving device for driving a liquid crystal display (LCD) monitor, the LCD monitor comprising an LCD panel for displaying a plurality of pixels arranged in a matrix format, the driving device comprising:
a power supply comprising a plurality of power transmission lines for carrying a plurality of voltages; and
a plurality of driving units capable of driving the LCD panel according to the voltages carried by the power transmission lines, each driving unit comprising:
an output buffer having a first input terminal and an output terminal connected to each other, the output terminal of the output buffer being connected to an output terminal of the driving unit; <a first switch coupled to a power source for selectively transmitting the power provided by the power source to turn on the output buffer; and
a second switch coupled between the output terminal of the driving unit and a second input terminal of the output buffer.

2. The driving device of claim 1, wherein the second input terminal is coupled to one of the power transmission lines.

3. The driving device of claim 2, wherein in a first period, the first switch is turned on and the second switch is turned off, and in a second period after the first period, the first switch is turned off and the second switch is turned on.

4. The driving device of claim 3, wherein in a third period before the first period, both the first and second switches are turned off.

5. The driving device of claim 1, wherein the driving unit further comprises:
a third switch coupled to one of the power transmission lines and the second input terminal of the output buffer.

6. The driving device of claim 5, wherein in a first period, both the first and third switches are turned on and the second switch is turned off, and in a second period after the first period, the first switch is turned off and both the second and third switches are turned on.

7. The driving device of claim 5, wherein in a third period before the first period, the first, second, and third switches are turned off.

8. A driving device for driving a liquid crystal display (LCD) monitor, the LCD monitor comprising an LCD panel for displaying a plurality of pixels arranged in a matrix format, the driving device comprising:
a power supply comprising a plurality of power transmission lines for carrying a plurality of voltages; and
a plurality of driving units capable of driving the LCD panel according to the voltages carried by the power transmission lines, each driving unit comprising:
an output buffer having a first input terminal coupled to one of the power transmission lines, an output terminal of the output buffer being connected to an output terminal of the driving unit;
a first switch coupled to a power source for selectively transmitting the power provided by the power source to turn on the output buffer; and
a second switch coupled between the first input terminal and a second input terminal of the output buffer.

9. The driving device of claim 8, wherein the driving unit further comprises:
a third switch coupled between the second input terminal of the output buffer and the output terminal of the driving unit.

10. The driving device of claim 9, wherein in a first period, both the first and third switches are turned on and the second switch is turned off, and in a second period after the first period, the first switch is turned off and both the second and third switches are turned on.

11. The driving device of claim 10, wherein in a third period before the first period, the first switch is turned off and at least one of the second and third switches is turned off.

12. The driving device of claim 8, wherein the second input terminal of the output buffer is connected to the output terminal of the driving unit.

13. The driving device of claim 12, wherein in a first period, the first switch is turned on and the second switch is turned off, and in a second period after the first period, the first switch is turned off and the second switch is turned on.

14. The driving device of claim 13, wherein in a third period before the first period, both the first and second switches are turned off.

15. A driving device for driving a liquid crystal display (LCD) monitor, the LCD monitor comprising an LCD panel for displaying a plurality of pixels arranged in a matrix format, the driving device comprising:
a power supply comprising a plurality of power transmission lines for carrying a plurality of voltages; and
a plurality of driving units capable of driving the LCD panel according to the voltages carried by the power transmission lines, each driving unit comprising:
an output buffer having a first input terminal coupled to one of the power transmission lines, an output terminal of the output buffer being connected to an output terminal of the driving unit;
a first switch coupled to a power source for selectively transmitting the power provided by the power source to turn on the output buffer;
a second switch coupled between the first input terminal of the output buffer and the output terminal of the driving unit; and
a third switch coupled between the output terminal of the output buffer and a second input terminal of the output buffer.

16. The driving device of claim 15, wherein in a first period, the first and third switches are turned on and the second switch is turned off, and in a second period after the first period, at least the first switch is turned off and at least the second switch is turned on.

17. The driving device of claim 16, wherein in a third period before the first period, at least the first and second switches are turned off.
